(19) United States
(12) Patent Application Publication
(10) Pub. No.: US 2024/0372374 A1
(43) Pub. Date: Nov. 7, 2024

(54) SYSTEMS AND METHODS FOR CONTROLLING A DUAL CELL BANK BATTERY

(71) Applicant: SAFIRE TECHNOLOGY GROUP, INC., McLean, VA (US)

(72) Inventors: Michael GRUBBS, Fairfax, VA (US); Andrew HANNA, Houston, TX (US); Nader SHOKAIR, Buena Park, CA (US)

(73) Assignee: SAFIRE TECHNOLOGY GROUP, INC., McLean, VA (US)

(21) Appl. No.: 18/656,501

(22) Filed: May 6, 2024

Related U.S. Application Data
(60) Provisional application No. 63/464,166, filed on May 4, 2023.

(51) Int. Cl. H02J 7/00; H01M 10/42; H01M 50/207; H01M 50/242; H01M 50/249

(52) U.S. Cl. CPC H02J 7/00032; H01M 10/425; H01M 50/207; H01M 50/242; H01M 50/249; H02J 7/0031; H01M 2010/4271; H01M 2220/20; H02J 2207/20

(57) ABSTRACT

Systems and methods for managing varying loads that can be applied to a dual cell bank battery include a dual cell bank battery including primary battery cell pack and a protective battery cell pack, wherein the protective battery cell pack at least partially encapsulates the primary battery cell pack. A battery management system determines which battery cell pack (either the primary battery cell pack or the protective battery cell pack) should be enabled to receive the load.

### CROSS-REFERENCE TO RELATED APPLICATIONS

This application claims priority to and the benefit of U.S. Provisional Application 63/464,166 filed on May 4, 2023. The content of the above application is incorporated herein by reference in its entirety.

### FIELD

The present disclosure relates to a dual cell bank battery, and more particularly, systems and methods for managing varying loads that may be applied to the dual cell bank battery.

### BACKGROUND

The statements in this section merely provide background information related to the present disclosure and may not constitute prior art.

Electric vehicles (EVs) use a rechargeable battery to power a vehicle, whereas traditional internal combustion engine (ICE) vehicles use an engine powered by hydrocarbon-based fuels. While the absence of hydrocarbon-based fuels within the operation of a vehicle may provide numerous benefits (such as reduced emissions), EVs have other challenges, such as limited range and charging stations for recharging the batteries. Additionally, in order to mitigate the risk of combustion of batteries in an impact event, protective structures are often added to the battery. However, the protective structures add weight to the vehicle, which can further reduce the range and functionality of the vehicle and the battery that powers the vehicle. In some circumstances, the protective structures added to the battery do not completely mitigate combustion of the battery, such as during an impact event.

The present disclosure addresses these issues related to the use and operation of rechargeable batteries in EVs.

### SUMMARY

This section provides a general summary of the disclosure and is not a comprehensive disclosure of its full scope or all of its features.

Provided are systems and methods for managing varying loads that are applied to a dual cell bank battery. In one aspect, the dual cell bank battery is comprised of a first battery cell pack and a second battery cell pack. As an example, the second battery cell pack encapsulates, or at least partially surrounds, the first battery cell pack. As another example, the second battery cell pack includes an electrolyte additive so that kinetic impact to the dual cell bank battery may be mitigated.

In another aspect, a battery management system receives a load from an inverter. For example, the load may be a current value, a temperature value, and/or a voltage value. The battery management system determines a specific value of the load. Based on the value of the load, the battery management system sends the load to either the first battery cell pack or the second battery cell pack. As an example, the battery management system sends the load to the first battery cell pack if the load has a high value, or is above a predetermined value. Alternatively, the battery management system sends the load to the second battery cell pack if the load has a low value, for example, below a predetermined value.

The present disclosure provides a system comprising: a battery management system configured to: identify a load, determine, based on the load, a value of the load, and send, based on the value of the load, the load to a primary battery cell pack or a protective battery cell pack, wherein the protective battery cell pack at least partially encapsulates the primary battery cell pack and includes an electrolyte additive; the primary battery cell pack configured to: receive the load in response to the battery management system determining that the value of the load exceeds a predetermined threshold; and the protective battery cell pack configured to: receive the load in response to the battery management system determining that the value of the load is below the predetermined threshold; wherein the battery management system is comprised of at least one of a field-effect transistor and a shunt, and wherein the shunt identifies the load received from an inverter; further comprising: an inverter configured to send the load to the battery management system, the primary battery cell pack, the protective battery cell pack, or a combination thereof; wherein the load is a current load, a temperature load, or a voltage load; wherein the primary battery cell pack is further configured to: output a corrected amperage of the load, wherein the corrected amperage indicates a value within a range associated with utilization of the primary battery cell pack; wherein the protective battery cell pack is further configured to: output a corrected amperage of the load, wherein the corrected amperage indicates a value within a range associated with utilization of the protective battery cell pack; wherein the battery management system is further configured to: switch between the protective battery cell pack and the primary battery cell pack based on an electrical current load sensing algorithm; wherein the battery management system is further configured to: monitor the load associated with the primary battery cell pack, the protective battery cell pack, or a combination thereof; wherein the battery management system is further configured to: redirect the load from the protective battery cell pack to the primary battery cell pack, wherein the redirection of the load is based on the monitoring of the load, and wherein the redirection of the load is further based on a determination that a current health of the protective battery cell pack is insufficient to process the load; wherein the battery management system is further configured to: process the load associated with the primary battery cell pack, the protective battery cell pack, or a combination thereof; wherein the battery management system is further configured to: determine a current health associated with the protective battery cell pack based on a state of charge of the protective battery cell pack, an internal cell temperature of the protective battery cell pack, an impedance associated with the protective battery cell pack, or a combination thereof; wherein the battery management system is further configured to: send the load to the primary battery cell pack based on a determination that a current health of the protective battery cell pack is insufficient to receive the load; wherein the battery management system is further configured to: send the load to the protective battery cell pack based on a determination that a current health of the protective battery cell pack is sufficient to receive the load; wherein the battery management system is further configured to: cause, based on an algorithm, a field-effect transistor associated with the primary battery cell pack to open in response to the battery management system determining that the value of the load exceeds the predetermined threshold; wherein the battery management system is further configured to: cause, based on an algorithm, a field-effect transistor associated with the protective battery cell pack to open in response to the battery management system determining that the value of the load is below the predetermined threshold.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a dual cell bank battery according to the present disclosure;

FIG. 2 is a block diagram illustrating an example system according to the present disclosure; and

FIG. 3 is a flowchart illustrating an example method for managing a load.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Various examples described herein provide a “dual” cell bank battery pack and a related Battery Management System (BMS) in which a standard battery pack bank is surrounded by a protective, ballistically durable secondary battery pack bank (also referred to as a protective battery cell pack) containing cells comprising a ballistic energy reducing chemistry. Various designs of the protective battery cell pack are illustrated and described in U.S. Pat. Nos. 9,590,274, 10,347,934, 10,637,100, 11,233,271, and 10,347,945, which are incorporated herein by reference in their entirety.

Layered or located proximate to the pack is a BMS that triggers the use of traditional cells in high discharge requests. In one implementation, the BMS is configured to utilize a specialized electrical current load sensing algorithm capable of switching between the protective battery cell pack and the standard battery cell pack of the same electrode chemistry. In another implementation, the BMS is configured to utilize a specialized electrical current load sensing algorithm capable of switching between the protective battery cell pack and the standard battery cell pack of varying electrode chemistry.

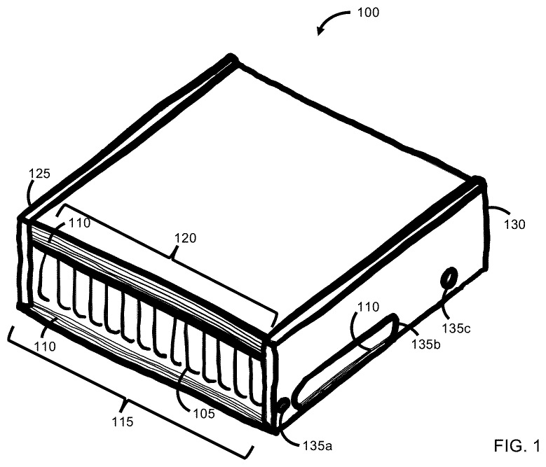

Referring to FIG. 1, a dual cell bank battery according to the present disclosure is illustrated and generally indicated by reference numeral 100. In some implementations, the dual cell bank battery 100 is a dual cell bank ballistic battery comprising a first battery cell pack 105 (e.g., a primary battery cell pack) and a second battery cell pack 110 (e.g., a protective battery cell pack). The first battery cell pack 105 may be a battery cell pack that is formed or formulated based upon a standard chemistry relative to the type of battery that may be used. For example, the first battery cell pack 105 may be a lithium-ion battery or a sodium-ion battery. However, it should be understood that any battery type may be used with the teachings of the present disclosure. It should also be understood that the standard chemistry that may be used for each of the lithium-ion battery or the sodium-ion battery may vary over time and thus the specific battery chemistries described herein should not be construed as limiting the scope of the present disclosure. In this form, the first battery cell pack 105 is comprised of a first plurality of batteries 115, wherein each battery of the first plurality of batteries 115 may be positioned in a vertical orientation relative to the second battery cell pack 110. It should be understood, however, that the first plurality of batteries 115 may be packaged in any orientation, or combination of orientations while remaining within the scope of the present disclosure.

The second battery cell pack 110 is a battery cell pack that is formed or formulated based upon a different chemistry relative to the chemistry used to formulate the first battery cell pack 105. However, it should be understood that the second battery cell pack 110 may be formed or formulated from the same chemistry as the chemistry used to formulate the first battery cell pack 105. For example, the second battery cell pack 110 may be a lithium-ion battery or a sodium-ion battery. However, it is understood that any battery type may be used. In the case wherein the second battery cell pack 110 may be a lithium-ion battery, an electrolyte additive may be added. The electrolyte additive may be included within the standard chemical formulation of the second battery cell pack 110 so that the effects of a kinetic impact to the second battery cell pack 110 may be mitigated. In an aspect, the second battery cell pack 110 may be susceptible to combustion caused from kinetic impact applied to the second battery cell pack 110 in the absence of the electrolyte additive. In another aspect, the electrolyte additive may provide ballistic characteristics to the dual cell bank battery 100 so that the use of protective structures may not be necessary to protect the dual cell bank battery 100. The second battery cell pack 110 may be comprised of a second plurality of batteries 120, wherein each battery of the second plurality of batteries 120 may be positioned in a horizontal orientation relative to the first battery cell pack 105. As such, in some examples, a stacked or sandwiched arrangement is provided.

The first battery cell pack 105 and the second battery cell pack 110 in this form are disposed between a first end plate 125 and a second end plate 130. As an example, each of the first end plate 125 and the second end plate 130 are formed from aluminum, an aluminum alloy, steel, or stainless steel material. As a further example, each of the first end plate 125 and the second end plate 130 are formed from a composite material, including a polymer matrix such as high-density polyethylene (HDPE), polypropylene, or acrylonitrile butadiene styrene (ABS), among others. It is understood that the entirety of the dual cell bank battery 100 may be disposed within a protective casing (not shown). It is also understood that while the electrolyte additive may provide for an arrangement wherein protective structures are not necessary, a protective casing may still be used to further protect the dual cell bank battery 100. It should also be understood that the protective casing may be formed from a non-metal, such as polymers (thermoplastics or thermosets), and fiber-reinforced polymers, among others.

Also shown in FIG. 1 are a plurality of vent holes (e.g., 135a, 135b, 135c) provided (e.g., drilled, or formed) into the second end plate 130 to dissipate heat, so as to mitigate any overheating of the dual cell bank battery 100 during operation. In an aspect, the plurality of vent holes (e.g., 135a, 135b, 135c) are provided into the second end plate 130 to allow for gas expansion in an unexpected degradation of performance or thermal runaway conditions. However, it should be understood that the plurality of vent holes (e.g., 135a, 135b, 135c) may also be provided in a variety of locations, including by way of example, the first end plate 125, or both the first end plate 125 and the second end plate 130. It should also be understood that the plurality of vent holes (e.g., 135a, 135b, 135c) may also have varying configurations, including Schrader valves and any other venting mechanisms.

The second battery cell pack 110 in one form is disposed on top of (and abutting in some examples) the first battery cell pack 105 so that the second battery cell pack 110 encapsulates the entirety of the first battery cell pack 105 (e.g., completely surrounds or encases the first battery cell pack 105) except for any number of incorporated design features including, but not limited to, any number of venting passages. It should be understood that the second battery cell pack 110 may partially encapsulate the first battery cell pack 105, i.e., on all but one side (or a portion of one side). Generally, and in a number of possible packaging configurations, the second battery cell pack 110 is configured to mitigate overheating of the first battery cell pack 105. The second battery cell pack 110 is electrically connected to the first battery cell pack 105 via a negative terminal (not shown) and a positive terminal (not shown).

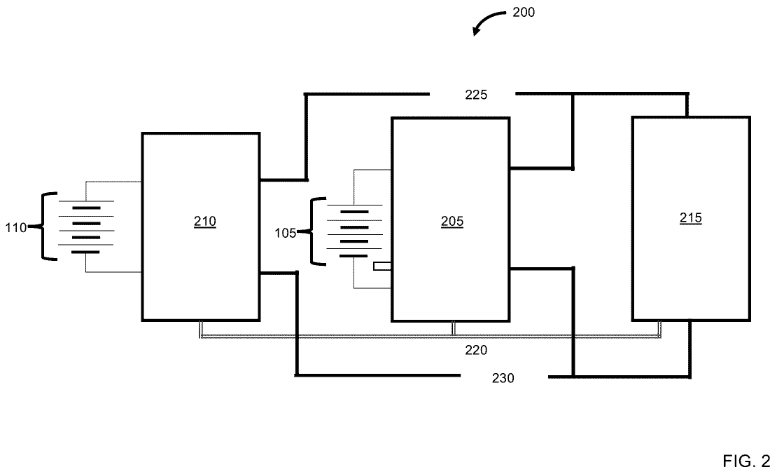

Referring to FIG. 2, in some examples, each of the first battery cell pack 105 and the second battery cell pack 110 are managed by respective battery management systems that together form a battery control system 200 (or other controller) that provides overall battery control for both the first battery cell pack 105 and the second battery cell pack 110. For example, the first battery cell pack 105 is managed by a first battery management system 205 and the second battery cell pack 110 is managed by a second battery management system 210. It should also be understood that each of the respective battery management systems are either physically coupled to the dual cell bank battery enclosure 140 or physically decoupled as a remote secondary enclosure (not shown). However, it should be understood that each of the first battery cell pack 105 and the second battery cell pack 110 may be managed by a single battery management system.

Each of the first battery management system 205 and the second battery management system 210 has a control unit (not shown) that communicates with each of the first battery cell pack 105 and the second battery cell pack 110, respectively. The control unit in one form is a local control unit that is configured to monitor current, voltage, and/or temperature of each of the first battery cell pack 105 and the second battery cell pack 110 via a shunt (not shown). It should be understood that the first battery management system 205 may have a first shunt (not shown) and the second battery management system 210 may have a second shunt (not shown). It should further be understood that the control unit may monitor the current, voltage, and/or temperature of each battery of the first plurality of batteries 115 and each battery of the second plurality of batteries 120. It should additionally be understood that the first battery management system 205 and the second battery management system 210 are each configured to redirect any of the loads associated with the current, voltage, and/or temperature from the second battery cell pack 110 to the first battery cell pack 105 based on a determination (e.g., by either the first battery management system 205 and the second battery management system 210) that a current health of the second battery cell pack 110 is insufficient to process the load.

Each of the first battery management system 205 and the second battery management system 210 are communicatively coupled to an inverter 215 via a communications bus 220. However, it is understood that each of the first battery management system 205 and the second battery management system 210 may be interconnected to any power-conducting component, not limited to only an inverter. The inverter 215 sends a current load, a voltage load, and/or a temperature load to each of the first battery cell pack 105 and the second battery cell pack 110. The inverter 215 supplies a positively oriented charge to each of the first battery management system 205 and the second battery management system 210 via a positive current pathway 225. The inverter 215 also supplies a negative charge to each of the first battery management system 205 and the second battery management system 210 via a negative current pathway 230. It should be understood that each of the positive current pathway 225 and the negative current pathway 230 may be respectively generated from a positive lead (not shown) and a negative lead (not shown) of the inverter 215. It should also be understood that each of the first battery management system 205 and/or the second battery management system 210 are configured to process the negative and/or positively oriented charges as well as the current load, the voltage load, the temperature load, or a combination thereof.

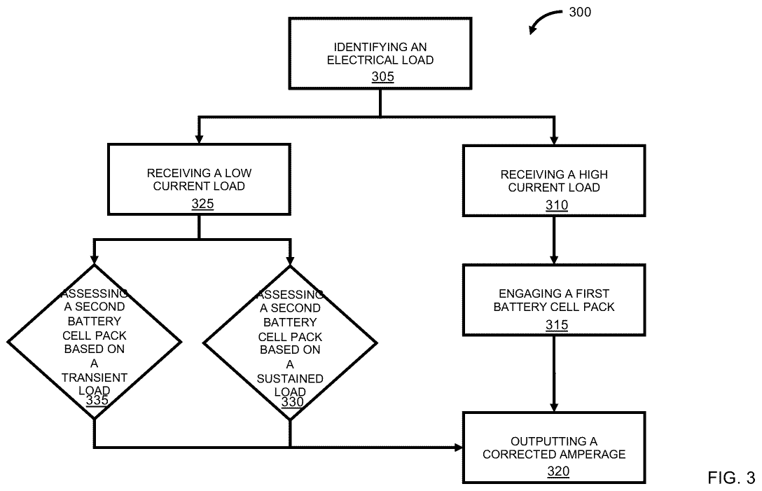

In one form, each of the first battery management system 205 and the second battery management system 210 has at least one or more field-effect transistors (FETs) (not shown). For example, the FETs may be a metal-insulator-semiconductor-FET (MOSFET). Each of the first battery management system 205 and the second battery management system 210 senses a current-based differential that is processed from the inverter 215 via at least one or more FETs. Based upon the current-based differential, a control process, such as is implemented as an algorithm described in FIG. 3, determines which of the first battery management system 205 or the second battery management system 210 enables either the first battery cell pack 105 or the second battery cell pack 110. For example, in the instance wherein the algorithm determines the first battery management system 205 is to be enabled, the first battery management system 205 opens the at least one or more FETs of the first battery management system 205 so that the first battery cell pack 105 may receive the current processed from the inverter 215. As another example, in the instance wherein the algorithm determines the second battery management system 210 is to be enabled, the second battery management system 210 opens the at least one or more FETs of the second battery management system 210 so that the second battery cell pack 110 may receive the current processed from the inverter 215.

Referring to FIG. 3, a process 300 is illustrated, in which the control unit of either the first battery management system 205 or the second battery management system 210 processes current, voltage, and/or temperature received from the inverter 215 (e.g., depicts the data flow of BMS control in high and low current draw conditions). It should be understood that the process 300 may be implemented through instructions derived from an algorithm. At step 305, the shunt identifies an electrical load received from the inverter 215. The electrical load may be indicative of a current-based differential, for example. In the case wherein the shunt receives a high current load, the current is directed, or sent, to the first battery cell pack 105 in step 310. For example, the high current load is a value that exceeds a voltage potential intrinsic to the chemistry of the given battery cell. By way of example, and as a function of battery chemistries, an upper voltage threshold is from about 3.1V to about 3.7V, and a lower threshold is from about 2.5V to about 2.75V. (The upper and lower thresholds are also referred to herein as predetermined thresholds). Further, the lower threshold should be understood as a load such that a voltage value intrinsic to the given battery cell chemistry drops to a suboptimal potential.

The first battery cell pack 105 is then engaged in step 315. In step 320, the first battery cell pack 105 outputs a corrected amperage. The corrected amperage is generally an amperage that has a value within the acceptable parameters for proper operation/utilization of the first battery cell pack 105. In other words, the corrected amperage indicates a value within a range associated with utilization of the primary battery pack or the protective battery pack.

Alternatively, in the case wherein the shunt receives a low current load, the current is directed, or sent, to the second battery cell pack 110 in step 325, at which point the health of the second battery cell pack 110 may be assessed to determine whether the current health of the second battery cell pack 110 qualifies the second battery cell pack 110 to be engaged. For example, the low current load is a value that drops to a suboptimal potential in consideration of the voltage value intrinsic to the chemistry of the given battery cell. It is understood that the assessment of the second battery cell pack 110 is determined based on a state of charge (Peukert exponent adjusted), internal cell temperature, impedance, or any other conventional method. For example, the current health of the second battery cell pack 110 may be determined sufficient to be enabled so that a sustained current load may pass through the second battery cell pack 110 in step 330. As another example, the current health of the second battery cell pack 110 may be determined sufficient to be enabled so that a transient load may pass through the second battery cell pack 110 in step 335. In either case (step 330 and/or step 335), if the health of the second battery cell pack 110 is determined sufficient to be enabled, the second battery cell pack 110 may output a corrected amperage in step 320. It is understood that the corrected amperage may be an amperage that may be valued within the acceptable parameters for proper utilization of the second battery cell pack 110.

In the case wherein the health of the second battery cell pack 110 is determined insufficient to be enabled in either steps 330 or step 335, the current load may be redirected to the first battery cell pack 105 so that the first battery cell pack 105 may be enabled.

In various examples, the herein described battery and control arrangements and configurations may be designed to operate at different C rates, including above 2C. For example, the second battery cell pack 110 may be limited in its application in some applications to C rates below 2C. In one or more implementations, the herein described examples “combine” different battery packs (e.g., ballistic configured and traditional batteries) so that operation in different applications may be allowed. In some examples, the second battery cell pack 110 is jacketed around the first battery cell pack 105, and a BMS is installed on top of the arrangement or system to turn “off” the second battery cell pack 110 when a high C rate discharge is requested. The BMS in some examples is communicatively coupled to one or more components or control units of the dual cell bank battery 100.

An operating environment that facilitates the performance of the systems and methods as is described herein may incorporate any of the components and/or functionality as is described herein. More specifically, the systems and methods described herein can be implemented on a computing device. For example, the computing device can be a personal computer, a desktop, a laptop, a tablet, a hand-held computer, a server, a workstation, a mainframe, a wearable computer, a supercomputer, or a combination thereof. However, it is understood that the aforementioned examples of what the computing device may be is non-exhaustive and that the computing device can be any related device. The computing device generally includes a processor, a display adapter, one or more input/output port(s), one or more input/output component(s), a network adapter, a power supply, and a memory. However, it is understood that the computing device can include any additional components therein and is not required to include any of the listed components (e.g., the processor, the display adapter, the one or more input/output port(s), the one or more input/output component(s), the network adapter, the power supply, and the memory).

The processor is configured to provide instructions and/or processing power to the computing device so that the computing device can process one or more tasks including the implementation of a software program. It is also understood that the computing device may include any number or processors therein. The display adapter can be a graphics card or a video board that provides the computing device with a capability to display content on a display device. For example, the display device can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device may be is non-exhaustive and that the display device can be any related device. The input/output port(s) provides a number of sockets for one or more cables to connect to the computing device. It is understood that there may be any number of input/output port(s) on the computing device. For example, the input/output port(s) provides a means for the computing device to receive signals and/or data from an external device connected to the computing device via the one or more cables. As another example, the input/output port(s) provides a means for the computing device to send signals and/or data from an external device connected to the computing device via the one or more cables. The input/output component(s) can include one or more components that support the input/output port(s) such as, but not limited to, a switch, a push button, a pressure mat, a float switch, a keypad, a radio receive, or a combination thereof.

A network adapter can be a network interface controller that is configured to provide a means for communicating over a network with another computing device, such as a remote computing device. For example, the remote computing device can be a user device such as a cellular-phone, a smartphone, a tablet, a laptop, or a combination thereof. The power supply is configured to convert alternating high voltage current (e.g., AC) into direct current (e.g., DC) to provide regulated power to the other components (e.g., the processor, the display adapter, the one or more input/output port(s), the one or more input/output component(s), the network adapter, and the memory) of the computing device.

Additionally, the memory can be a mass storage device and/or a system memory such as a hard disk drive, a memory card, a solid-state drive, random access memory (RAM), or a combination thereof. The memory is configured to provide a holding place for instructions and data associated with the operation of the computing device. The memory can generally include an operating system, load software, and load data. For example, the operating system is configured to manage and/or process any of the data and/or instructions associated with the load software and/or load data. Furthermore, a system bus is also included within the computing device that is configured to couple each of the various components (e.g., the processor, the display adapter, the one or more input/output port(s), the one or more input/output component(s), the network adapter, the power supply, and the memory) of the computing device. It is also understood that each of the components of the computing device, and the functionality associated with each of the components of the computing device, may be implemented within the remote computing device. While the operating environment is described as having a particular configuration associated with at least the computing device, the network, and the remote computing device it is understood that the operating environment may be configured in any way.

Thus, the teachings of the present disclosure provide a battery having a protective cell pack design, enclosing (at least partially), as a “jacket,” the traditional cells with a battery cell pack bank containing an additive, imparting ballistic qualities to the cell in the moment of impact. In various implementations, this may remove the requirement of designing dense protective structures into an EV or other chassis requiring battery power on-board, while providing improved protection from severe degradation of standard battery packs surrounded by the additive-containing cell packs. In one or more examples, the batteries disclosed herein combine elements of two functioning battery pack systems into a novel capability for a battery pack system under varying loads. The controllers or control arrangements described herein are utilized to independently control the electrical current input and output flow of the additive-containing battery cell pack bank and the standard cell pack bank based on apparent load, temperature, among other operational conditions.

It should be appreciated that designing a battery pack for EVs and other applications may involve engineering considerations regarding structural protection in order to avoid significant degradation in the form of combustion from an impact event. Unlike added protective structures that increase vehicle weight and, if compromised, do not address the issue of electrode shorting due to the crushing forces of impact, which could lead to undesirable conditions, the teachings of the present disclosure provide a unique approach to a light-weight, protective, battery system. For example, the dual cell battery pack arrangement provides both improved ballistic protection of battery chemistries, while itself providing an auxiliary power source to the vehicle. Using one or more of the herein described examples, structural engineering and design requirements of protective structures in the vehicle may be reduced or eliminated, saving weight and providing an improved battery system. Also contemplated are electric vehicles incorporating the teachings herein, such as by way of example any motor vehicle as defined in 18 U.S.C. § 31 (a) (6), among others.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
identifying, by a battery management system, a load;
determining, based on the load, a value of the load; and
sending, based on the value of the load, the load to a primary battery cell pack or a protective battery cell pack.

2. The method of claim 1, wherein the load is a current value, a temperature value or a voltage value.

3. An apparatus comprising:
a primary battery cell pack and a protective battery cell pack, wherein the protective battery cell pack at least partially encapsulates the primary battery cell pack and includes an electrolyte additive.

4. An electric vehicle comprising the apparatus according to claim 3.

5. A system comprising:
a battery management system configured to:
identify a load,
determine, based on the load, a value of the load, and
send, based on the value of the load, the load to a primary battery cell pack or a protective battery cell pack, wherein the protective battery cell pack at least partially encapsulates the primary battery cell pack and includes an electrolyte additive;
the primary battery cell pack configured to:
receive the load in response to the battery management system determining that the value of the load exceeds a predetermined threshold; and
the protective battery cell pack configured to:
receive the load in response to the battery management system determining that the value of the load is below the predetermined threshold.

6. The system of claim 5, wherein the battery management system is comprised of at least one of a field-effect transistor and a shunt, and wherein the shunt identifies the load received from an inverter.

7. The system of claim 5, further comprising:
an inverter configured to send the load to the battery management system, the primary battery cell pack, the protective battery cell pack, or a combination thereof.

8. The system of claim 5, wherein the load is a current load, a temperature load, or a voltage load.

9. The system of claim 5, wherein the primary battery cell pack is further configured to:
output a corrected amperage of the load, wherein the corrected amperage indicates a value within a range associated with utilization of the primary battery cell pack.

10. The system of claim 5, wherein the protective battery cell pack is further configured to:
output a corrected amperage of the load, wherein the corrected amperage indicates a value within a range associated with utilization of the protective battery cell pack.

11. The system of claim 5, wherein the battery management system is further configured to:
switch between the protective battery cell pack and the primary battery cell pack based on an electrical current load sensing algorithm.

12. The system of claim 5, wherein the battery management system is further configured to:
monitor the load associated with the primary battery cell pack, the protective battery cell pack, or a combination thereof.

13. The system of claim 12, wherein the battery management system is further configured to:
redirect the load from the protective battery cell pack to the primary battery cell pack, wherein the redirection of the load is based on the monitoring of the load, and wherein the redirection of the load is further based on a determination that a current health of the protective battery cell pack is insufficient to process the load.

14. The system of claim 5, wherein the battery management system is further configured to:
process the load associated with the primary battery cell pack, the protective battery cell pack, or a combination thereof.

15. The system of claim 5, wherein the battery management system is further configured to:
determine a current health associated with the protective battery cell pack based on a state of charge of the protective battery cell pack, an internal cell temperature of the protective battery cell pack, an impedance associated with the protective battery cell pack, or a combination thereof.

16. The system of claim 5, wherein the battery management system is further configured to:
send the load to the primary battery cell pack based on a determination that a current health of the protective battery cell pack is insufficient to receive the load.

17. The system of claim 5, wherein the battery management system is further configured to:
send the load to the protective battery cell pack based on a determination that a current health of the protective battery cell pack is sufficient to receive the load.

18. The system of claim 5, wherein the battery management system is further configured to:
cause, based on an algorithm, a field-effect transistor associated with the primary battery cell pack to open in response to the battery management system determining that the value of the load exceeds the predetermined threshold.

19. The system of claim 5, wherein the battery management system is further configured to:
cause, based on an algorithm, a field-effect transistor associated with the protective battery cell pack to open in response to the battery management system determining that the value of the load is below the predetermined threshold.
